(19) United States
(12) Patent Application Publication
(10) Pub. No.: US 2015/0141105 A1
(43) Pub. Date: May 21, 2015

(54) APPARATUS AND METHOD FOR PROVIDING CASINO CARD GAME

(71) Applicant: Diversified Casino Services LLC, Valley Center, CA (US)

(72) Inventors: Tellypuu Quisquis, Valley Center, CA (US); James Quisquis, Valley Center, CA (US)

(21) Appl. No.: 14/531,939

(22) Filed: Nov. 3, 2014

Related U.S. Application Data
(60) Provisional application No. 61/905,089, filed on Nov. 15, 2013.

(51) Int. Cl. A63F 1/00; G07F 17/32

(52) U.S. Cl. CPC A63F 1/00; G07F 17/3244; A63F 2001/008
USPC 463/11; 273/292

(57) ABSTRACT

Methods and systems are disclosed for a casino card game in which players place blind bets and are dealt an initial hand of at least two cards. If a player is dealt a predetermined hand, such as a natural 21, they are declared an instant winner. If there are no instant winners, each player is given the option to hit or stand. Players can hit up to the point where there hand reaches or exceeds a threshold value, such as 21. Once the round has completed, the dealer reviews the hand of each player and declares a winner.

This application claims the benefit of U.S. Provisional Application No. 61/905,089, titled, “CASINO CARD GAME”, filed Nov. 15, 2013, which is incorporated by reference herein in its entirety.

### TECHNICAL FIELD

The subject matter of this application relates to games of chance. Specifically the subject matter relates to methods and systems for providing a casino-type card game.

### BACKGROUND

Card games such as blackjack and poker are some of the most widely played wagering games at casinos. However, demand exists for new types of card games. Blackjack, although relatively simple and easy to learn, is played against a casino dealer. This leads to a distinct house advantage which can be unappealing to some players. Poker, although typically not played against a house dealer, tends to be more complex and can intimidate novice players. A new casino card game is needed that is easy to learn, but does not place each player in competition with a house dealer.

### BRIEF DESCRIPTION OF THE DRAWINGS

The present embodiments are illustrated by way of example and are not intended to be limited by the figures of the accompanying drawings. In the drawings:

FIG. 1 shows a flow chart of an example method of playing a card game according to the rules of some embodiments of the present disclosure;

FIG. 2 shows a first example card table surface for playing a game such as described herein;

FIG. 3 shows a second example card table for playing a game such as described herein;

FIG. 4 shows a high-level schematic diagram of a computer system for playing a game as described herein;

FIG. 5 shows an example multiplayer game device for playing a game such as described herein; and

FIG. 6 shows a high-level schematic diagram of a system for playing an online game such as described herein.

### DETAILED DESCRIPTION

From the foregoing, it will be appreciated that specific embodiments of the invention have been described herein for purposes of illustration, but that various modifications may be made without deviating from the scope of the invention. Accordingly, the invention is not limited except as by the appended claims.

### Overview

Introduced here is a casino-type card game. To facilitate description, the card game is referred to herein as “Draw 21.” The term “Draw 21” is used interchangeably herein, only to facilitate explanation, with other terms such as “card game,” “wagering game,” “casino game,” or simply “game.”

In general, Draw 21 differs from traditional blackjack in that players compete with other players instead of only with the dealer thereby alleviating the house advantage associated with blackjack. Draw 21 differs from poker in that is a provides a quicker more accessible gameplay to players of all skill levels. Players compete with each other instead of with a dealer and do not risk losing the game by drawing too many cards or “busting.” Accordingly, decisions on player action to draw an additional card are more straightforward, even for novice players. Streamlined decision making allows for a rapid pace of gameplay as players can draw cards until a winner is determined.

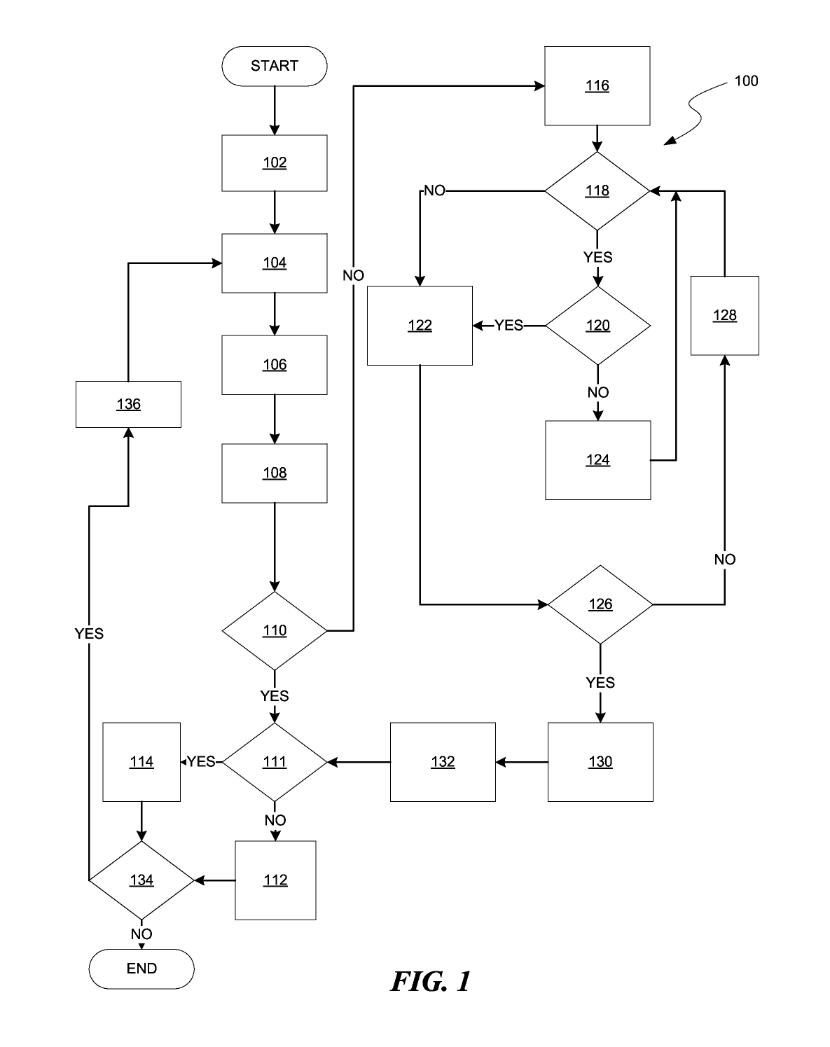

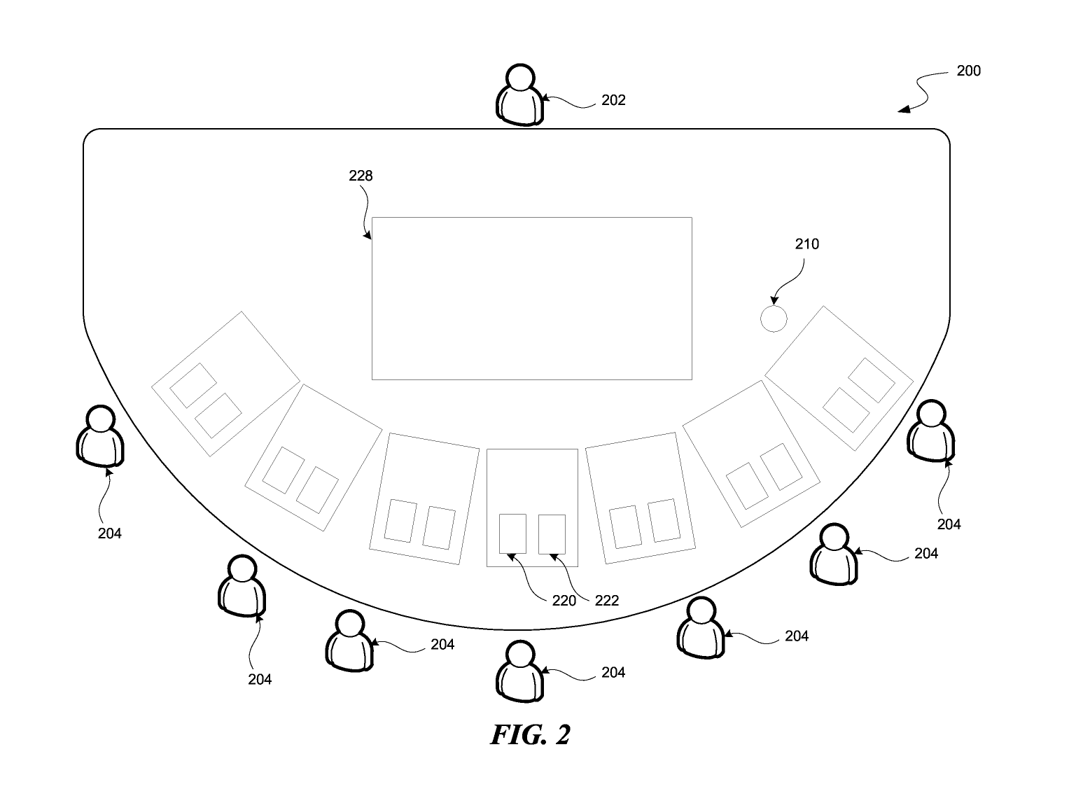

FIG. 1 shows a flow chart 100 of an example method of playing a game of “Draw 21” according to the rules of some embodiments of the present disclosure. In an embodiment, the game includes a house dealer 202 and a plurality of players 204. The house dealer 202 is positioned on one side of a physical card table with the plurality of players 204 positioned on the other side as shown in FIG. 2. While FIG. 2 shows an example game table 200 with seven player positions, note that the game may be played among less than or more than seven players, as long as there are at least two players to play against each other.

Returning to FIG. 1, the game begins at step 102 with the house dealer 202 placing a “dealer button” (e.g. button 210 in FIG. 2) in front of one of the plurality of players 204 indicating that this player is the “player dealer.” Designation as a “player dealer” is for reference and does not impact the way in which that player plays the game. Further, the step of designating a player dealer is not necessary to the game, but is useful to inform the order of dealing cards, receiving bets, and player actions as will be described later. The game may be played without designating a player dealer while remaining within the scope of the present disclosure.

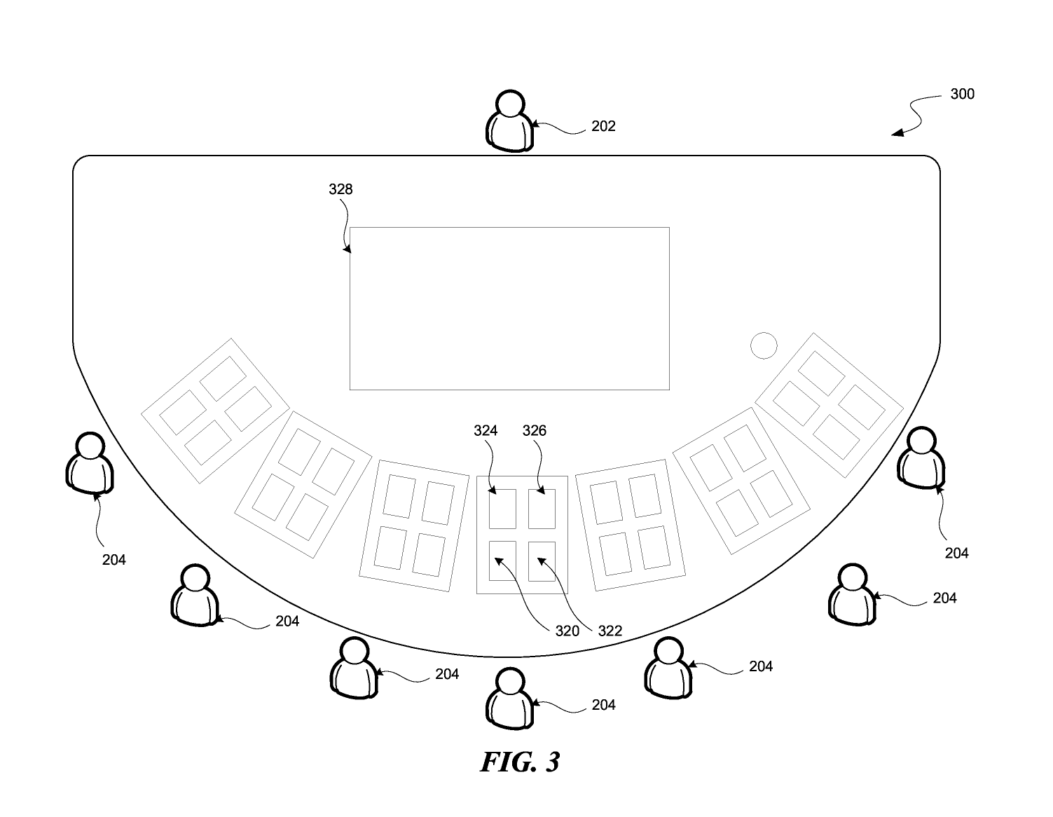

Once the house dealer 202 has placed the dealer button 210, at step 104 the house dealer 202 requests all players 204 to place blind bets in designated areas on the card table. A blind bet is a forced bet posted by players before they have seen their dealt cards. According to some embodiments the blind bets may include both a big blind and a small blind. In such embodiments, the small blind represents the smaller of two fixed-limit bets (e.g. $2), while the big blind represents the larger of two fixed limit bets (e.g. $4). The game provider (i.e. the house) sets the big blind and small blind limits. In an example embodiment, both the big blind and small blind is required of all players before the cards are dealt. In another example embodiment, the small blind is required of all players on an initial round, while the big blind is required of all players on a subsequent round. In yet another embodiment, the small blind is required of players before any cards are dealt, while the big blind is required of players that wish to draw additional cards. As shown in FIG. 2, an example card table 200 include designated areas for a big blind 220 and a small blind 222 at each of a plurality of player positions. According to some embodiments the house (i.e. the casino or other provider/manager of the game) or house dealer 202 sets betting limits on the blind bets. According to some embodiments, at this time players 204 may also be required to place an ante and/or a bonus side bet. For example, FIG. 3 shows an example game table 300 according to other embodiments. As shown in FIG. 3, an example card table 300 includes designated areas for antes 324, and side bets 326 as well as designated areas for big blinds 320 and small blinds 322. In all cases, blind bets, antes, and or side bets can be placed by players 204 by placing physical “chips” or “tokens” representing various denominations of currency on the game table (e.g., table 200 or 300) within the designated areas.

Once the all bets have been placed, at step 106, the house dealer 202 shuffles the cards and deal two cards to each player face down on the table. The game is played with one or more standard 52-card decks, also known, as “French Decks.” A standard 52-card deck consists of thirteen ranked cards of each of four suits, clubs, diamonds, hearts, and spades. The thirteen ranks consist of numbered cards (two through ten), face cards (Jack, Queen, King), and an Ace. Each card dealt is associated with a value. Typically numbered cards are assigned the value on their face (e.g. a three card has a value of 3), while face cards (e.g. Jack, Queen, King) are assigned a value of 10. An Ace is typically assigned a value of either 1 or 11 depending on the situation, player election, or the rules of the particular game of blackjack. According to some embodiments, at step 108, the house dealer 202 starts dealing cards to the left of the “player dealer” (i.e. the player with the dealer button), however the dealing of cards can be performed in any order as long as each player receives an initial hand of (in at least some embodiment) two cards.

After dealing the initial hand of two cards to each of the plurality of players 204, each of the plurality of players 204 may look at the hand they have been dealt. At decision 110, the house dealer 202 inquires if any of the plurality of players have a predetermined hand. According to some embodiments, this predetermined hand is a “Natural 21.” A “Natural 21” is an Ace card accompanied by a card with a value of 10 such as a ten card, Jack card, Queen card, and King card. According to traditional blackjack scoring rules the combination of an Ace card and a card with a value of 10 holds special significance as the highest possible combined value on the initial deal without “busting” (i.e. going over 21). However, according to some embodiments of the present disclosure, this predetermined hand can be set to something different. For example, the predetermined hand may be two Aces, two Kings, an Ace plus a King, an Ace and Jack of the same suit, or any predetermined combination of two cards.

If any of the plurality of players 204 in the game have the predetermined hand, they announce as such, and after verifying this to be the case, the house dealer 202 declares those one or more of the plurality of player 204 to be the instant winners of the round. In embodiments in which only the blind bets are placed (e.g. as in a game played on table 200 in FIG. 2), the house dealer collects all of the bets into a pot and distributes at least a portion of the pot to the one or more winning players. In cases where two or more players 204 are dealt the predetermined hand, the house dealer 202, at step 114, can split the pot (e.g., evenly) between the two or more winning players. Otherwise, if only one player is declared a winner, the dealer 202 at step 112 will distribute winnings from the pot only to that winning player. This determination is reflected in flowchart 100 at decision 111.

As mentioned above, according to some embodiments, prior to the initial deal, players 204 are allowed to place a “bonus” or “side” bet in a designate area on the card table, for example, the “Natural 21 Bonus” designated area 326 as shown in FIG. 3. According to some embodiments, the house or house dealer 202 sets limits on the amount that a player 204 may place in the side bet. For example, the house may set a limit at twice the amount of the big blind bet. If a player 204 places a side bet in the designated area 326 and is subsequently dealt the predetermined hand on the initial deal by the house dealer 202, the house dealer 202 pays that winning player (or multiple winning players) a bonus payout from the house bank in addition to the pot collected from the bets of the other players 204. According to some embodiments, the bonus payout is based on the specifics of the predetermined hand. For example, according to some embodiments, a natural 21 (Ace card plus a card with a value of 10) pays out at 1:1. In other words, if a player 204 wins on the initial deal with a natural 21 after placing a side bet of $10, the house will pay out a bonus to that player of $10, which the player will receive in addition to the pot. The house may also set a rule that a natural 21 of the same suit may pay out at 2:1. In other words, if that same player 204 placed a side bet of $10 and is dealt an Ace of spades and a 10 of spades, the house will pay out a bonus of $20 to that player. Alternatively, the house can set bonus payouts based on the number of predetermined hands that result from the initial deal in a given round. For example, the house can set a rule that one predetermined hand pays out at 1:1, two predetermined hands pay out at 2:1, three predetermined hands pay out at 25:1, and four predetermined hands pay out at 100:1. Consider the following scenario: four players 204 are playing the card game. Each of the four players places a side bet. Player 1 places a side bet of $10, player 2 places a side bet of $15, player 3 places a side bet of $30 and player 4 places a side bet of $50. The house dealer 202 deals an initial hand to all four players and inquires if there are any natural 21s. To the house dealer's surprise, all four players exclaim that they have a natural 21. According to the rules previously mentioned, the house would then pay out at 100:1. Here, player 1 would receive $1000, player 2 would receive $1500, player 3 would receive $3000, and player 4 would receive $5000. In this scenario the four players would also split (e.g., evenly) the pot.

If there are no predetermined hands (e.g. natural 21s) after the initial deal, then at step 116 the game proceeds to player action. Each player 204, having viewed his hand, is provided an option by the house dealer 202, represented at decision 118, to take additional cards (i.e., “hit”) or stay with his cards (i.e., “stand”). In other words, at decision 118, if the player 204 decides to hit, the process continues to decision 120 (described below) and if the player 204 decides not to hit, then at step 122 that player's action is completed. According to the rules of some embodiments, a player 204 may hit as many times as he wants, but may not hit for an additional card if his current hand is at a threshold value (e.g. 21) or higher. In other words at decision 120, if the current player's hand is at or over a threshold value (e.g. 21) the player action is completed at step 122. However, if at decision 120, the player's 204 hand is not at or above the threshold value, the house dealer 202 at step 124 deals another card to the player 204. Unlike in traditional blackjack, in this game, a player 204 does not bust if his hand goes over the threshold value (e.g., 21). A player 204 with a hand over the threshold value (e.g., 21) remains in the game, but will not be allowed to hit for any more additional cards. As previously mentioned, Ace cards may be valued at 1 or 11 depending on the rules set by the house, or player's choice. For example, a player 204 may wish to count an Ace as a card value of 1 in a situation where it is strategically advantageous to draw an additional card.

According to some embodiments player action proceeds in the same order as the order used to deal the cards in the initial deal. For example, if in the initial deal, the house dealer 202 places the “dealer button” next to a player 204, that player is designated the player dealer and is dealt his cards last. The house dealer 202 begins dealing to the left of the player dealer and deals to each player 204, ending on the player dealer. Accordingly, the house dealer 202 would provide the options to take action to the player 204 to the left of the player dealer and proceed through the other players 204 ending on the player dealer. This progression is represented in flow chart 100 at decision 126, where if all players 204 have taken player action, the process continues to step 130 (described below) and if all players 204 have not taken player action the house dealer, at step 128, continues to the next player 204 to provide the option to hit or stand, again represented at decision 118. As previously mentioned, this order of dealing is not necessary to the game, and there are a number of possible ways in which to set the order for dealing and player action.

Once all the players 204 have taken their action (either hitting or standing), at step 130 the house dealer 202 will reviews the hands of each player, and at step 132 determine the one or more winning hands, and declares the one or more players 204 with the winning hands the winning players. According to some embodiments, at step 130, the house dealer 202 reveals or requests each player 204 to reveal their hands in order instead of all at one time. For example, according to an embodiment, once player action is complete, the house dealer 202 reveals the cards of the player 204 to the left of the player dealer (the player with the dealer button 210). This revealed hand is now the hand to beat and the house dealer 202 moves on to reveal the hand of a second player. If this second player's hand beats the first players hand, the first player has lost. The house dealer 202 takes the received bets from the first player, places those received bets in a pot, and continues to a third player. The pot is a designated area on the surface of the card table in front of the house dealer. For example, card table 200 shown in FIG. 2 includes designated pot area 228. Similarly, card table 300 shown in FIG. 3 includes designated pot area 328. If this second player's hand does not beat the first player's hand, the second player has lost. The house dealer takes the received bets from the second player, places those received bets in the pot, and continues to the third player. If the second player's hand is the same as the first player's hand these players are tied and will share in the winnings if none of the remaining hands beat them. This process continues until all player hands are revealed and one or more winning hands are determined.

In general, determining the one or more winning hands at step 132 is based on the value of the cards in each player's 204 hand after player action has concluded. The house defines what constitutes a winning hand. As previously mentioned, players may hit as many times as they like but may not do so once their hand has reached a threshold value (e.g., 21), however unlike in blackjack, players 204 do not bust if they go over the threshold value (e.g., 21). Therefore, according to the rules of some embodiments, the hand with the highest value in comparison to all other hands may be determined to be the winning hand. Alternatively, the hand with a value closest (either over or under) to the threshold value (e.g., 21) may be determined to be the winning hand. Alternatively, the highest poker hand may be determined to be the winning hand. In general, poker hands consist of ranked categories of combinations of one to five cards. categories combinations generally include (ranked form lowest to highest), highest value card, one pair (pair of like-valued cards), two pair (two pairs of like-valued cards), three of a kind (three like-valued cards), straight (five cards in sequence, e.g., 5, 6, 7, 8, and 9), flush (five cards of the same suit), full house (one pair plus three of a kind), four of a kind (four like-valued cards), and straight flush (straight in which all five cards are of the same suit). For example, according to the rules of some embodiments, a hand comprising five cards representing a full house while at or below a value of 21 (e.g., three 2 cards, and two 3 cards) may beat a hand with a higher total face value (e.g. and King, Queen, and Ace).

Once the house dealer 202 has declared one or more winning players, the house dealer 202 will collect all the blind bets (and antes and side bets if applicable) into a pot and distribute at least a portion of the pot to the one or more winning player. If two or more players have even hands and therefore tie for the win, the house dealer 202 splits the pot (e.g., evenly) among the winning players. Again, this is represented at decision 111 in flow chart 100. If there are two or more winners, the house dealer 202 at step 114 split (e.g. evenly) at least a portion of the pot among the two or more winning players. However there is only one winning player, at step 112 the house dealer distributes at least a portion of the pot to that wining player.

At decision 134, the game either continues to a new round or ends. If the game continues to a new round, at step 136, the house dealer 202 advances the “dealer button” to the next player, for example, the player to the left of the last “player dealer.” As previously mentioned, the steps of placing and advancing a “dealer button” to keep track of the order of card dealing are not necessary to the rules of the game described herein. Cards may be dealt and revealed by the house dealer 202 in any order that the house dealer determines. After step 136, the house dealer 202 again requests at step 104 that all players 204 place blind bets in designated areas on the card table. The steps described in flow chart 100 then repeat

So far, this specification has described a card game in which players 204 bet and play against each other and not the house dealer 202. This arrangement alleviates the skewed house advantage present in most casino blackjack games. However, the host or provider of the card game (e.g., a casino or “the house”) may still wish to monetize the game as it is played, particularly if that host or provider is paying out bonuses to players based on placed side bets. To do so, according to the rules of some embodiments, at the end of each round, the house dealer 202 can collect a percentage of the pot as a fee for playing the game before distributing to the winning player(s). This is sometimes referred to as a “rake.” For example, the house can set a rake of between 2% to 5% of the pot at the end of each round. According to embodiments in which players 204 are required to place an ante in a designated area, the house dealer 202 can collect the placed antes as a fee for playing the game. According to some embodiments, the house dealer 202 can collect both the placed antes as well as a percentage of the remaining pot as a fee for playing the game.

### Computer-Implementation

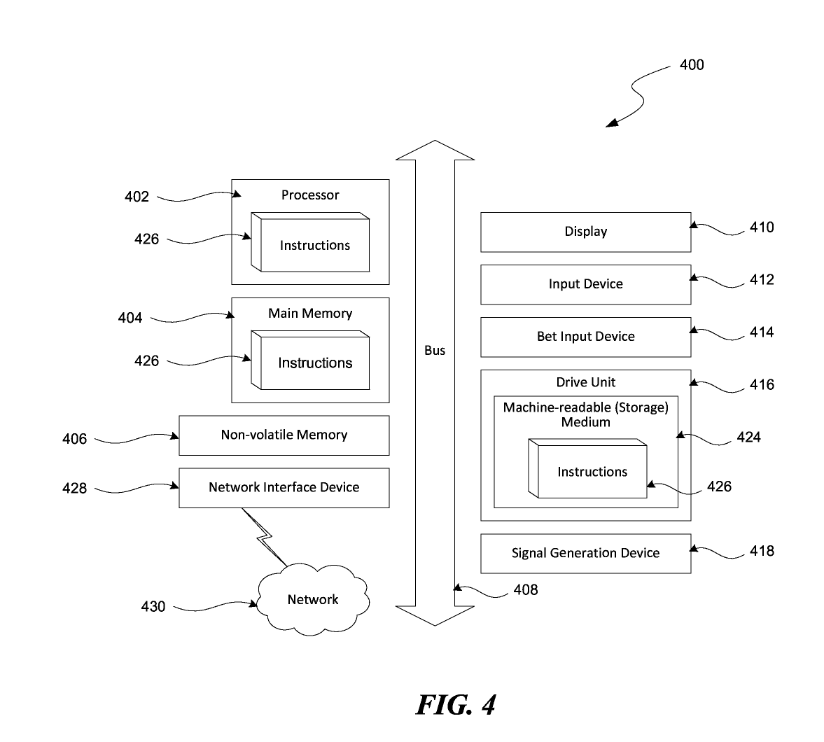

Draw 21, or a similar card game as described in the previous section may also be implemented as a computerized card game. FIG. 4 shows a high-level schematic diagram of a computer system 400 within which sets of instructions are executed for causing the computer system to perform the methodologies disclosed herein. In various alternative embodiments, the computer system may be or include a server computer, a client computer, a personal computer (e.g., Apple iMac®), a tablet device (e.g., Apple iPad®), a phablet device (e.g., Samsung® Galaxy Note), a laptop computer (e.g., Macbook Air®), a set-top box (STB), a personal digital assistant (PDA), a thin-client device, a cellular telephone, a smartphone (e.g. Apple iPhone®), a processor, a telephone, a web appliance, a microconsole (e.g., Apple TV®), a game console (e.g., Microsoft Xbox One®), a hand-held game console (e.g. Sony PlayStation Vita®, a dedicated arcade game device, a music player (e.g. iPod®), any portable, mobile, hand-held device, or any machine capable of executing a set of instructions (sequential or otherwise) that specify actions to be taken by that machine.

In an embodiment, the example computer system 400 includes a processor 402, a main memory 404 and a static memory 406, which communicate with each other via a bus 408. The computer system 400 further includes a display unit 410, for example, a liquid crystal display (LCD) or a cathode ray tube (CRT). The computer system 400 also includes an input device 412, for example, a keyboard, mouse, touch screen display, or any other device capable of receiving a user input. According to some embodiments, the alphanumeric input device and cursor control device 412 may be integrated with the display unit 410, for example as a touch screen liquid crystal display. The computer system 400 also includes a bet input device 414 configured to receive a bet from a user. In some embodiments, the bet input device 414 is the same as the general input device 412. For example, a touch screen display 412 may receive inputs from a user indicating a desired bet. In some embodiments, the bet input device 412 is configured specifically to receive a token, bill or signal indicating a bet amount. For example, in some embodiments, bet input device 412 is a card readers (capable of reading a credit card or ATM card), a bill reader (capable of receiving and detecting various paper currency), coin/token slot, or any other input device capable of receiving a bet as an input. Computer system 400 also includes a disk drive unit 416, a signal generation device 418, for example, a speaker, and a network interface device 428.

The disk drive unit 416 may include a machine-readable medium 424 on which is stored a set of executable instructions, i.e., software, 426 embodying any one, or all, of the methodologies described herein below. The software 426 is also shown to reside, completely or at least partially, within the main memory 404 and/or within the processor 402. The software 426 may further be transmitted or received over a network 430 by means of a network interface device 428.

While the machine-readable medium 424 or machine-readable storage medium is shown in an exemplary embodiment to be a single medium, the term “machine-readable medium” and “machine-readable storage medium” should be taken to include a single medium or multiple media (e.g., a centralized or distributed repository, and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies of the presently disclosed technique and innovation.

Examples of machine-readable media 424 or “machine-readable storage media,” or “computer-readable (storage) media” include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In general, the routines executed to implement the embodiments of the disclosure, can be implemented as part of an operating system or a specific application, component, program, object, module or sequence of instructions referred to as “computer programs.” The computer programs typically comprise one or more instructions (e.g. instructions 426) set at various times in various memory 404 and storage devices 416/406 in the computer system 400, and that, when read and executed by one or more processors 402 in a computer 400, cause the computer 400 to perform operations to execute elements involving the various aspects of the disclosure.

The network interface device 428 enables the computer system 400 to mediate data in a network (e.g., network 430) with an entity that is external to computer system 400, through any known and/or convenient communications protocol supported by the host and the external entity. The network interface device 428 may include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network interface device 428 may include a firewall which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall can additionally manage and/or have access to an access control list which details permissions including for example, the access and operation rights of an object by an individual, a machine, and/or an application, and the circumstances under which the permission rights stand.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

In contrast to the system 400 discussed above, other embodiments may use hardware-based logic circuitry instead of computer-executed software instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip

(DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

According to some embodiments, Draw 21 or a similar card game is implemented via a computer as a special-purpose standalone game device. In such embodiments, one or more sets of instructions stored on a memory device cause a processor to provide a game of Draw 21 or a similar card game according to the rules discussed above. According to some embodiments, a standalone game device may be intended for a single user with one or more computer-controlled bots representing one or more other players. Such an device can be implemented as a machine with a single associated display (e.g., a home game console or video arcade game device). Alternatively a standalone game device may include multiple inputs and displays intended to accommodate a plurality of live players.

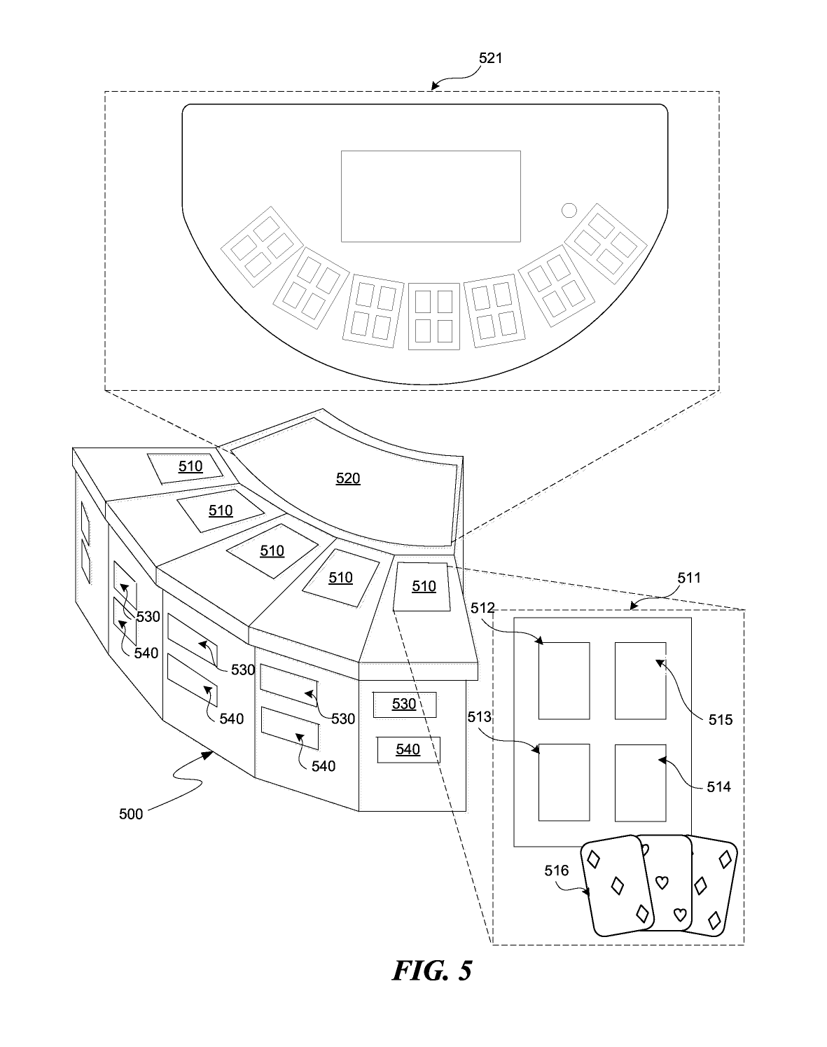

FIG. 5 shows an example standalone game device 500 with multiple inputs, according to some embodiments. Game device 500 is shown in FIG. 5 as a multiplayer device, however, a similar game device intended for a single human player is also contemplated. Such a single player device may include components similar to game device 500 but include only one of the five shown player stations. As shown in FIG. 5, example game device 500 includes five player stations able to provide a video casino game to five human players. Each player station includes a display/input device 510 (similar to input device 412 with reference to FIG. 4). In FIG. 5, the display and input device 510 are integrated as a touch screen interface capable of displaying rendered images and receiving player inputs in the form of touch gestures. However, game device 500 could alternatively include a separate input device such as joystick or set of buttons. Each player station also includes a bet input device 530 (similar to bet input device 414 with reference to FIG. 4). Through bet input device 530, players can input bets to be placed during the game. For example, bet input device 530 may be a card reader (capable of reading a credit card or ATM card), a bill reader (capable of receiving and detecting various paper currency), coin/token slot, or any other input device capable of receiving a bet as an input. Each player station also includes a payout device 540. Winnings are paid out to players by game device 500 via payout device 540. For example, payout device may be a card reader (capable of reading a credit card, ATM card, etc.), a coin/token dispenser (capable of dispensing tokens), or a bill dispenser (capable of dispensing paper currency). According to some embodiments, payout device 540 is integrated with bet input device 530. According to some embodiments, game device 500 also includes a main display 520 that displays the entire playing table to all players of the game.

FIG. 5 also shows example graphical displays/interfaces that may be displayed via displays 510/520. As shown in FIG. 5, according to some embodiments, each player station display 510 displays to the player an interface 511 that consists of designated areas 512-515 (similar to designated areas 320-326 with reference to FIG. 3) on which a player may place bets. For example, in one embodiments, in order to place an big blind bet, a player places a token in the amount of the required big blind into bet input device 530 and touches display/input device 510 in the region of designated area 514 in order to place the big blind bet. Interface 511 also includes a display of the players dealt cards 516. According to some embodiments, display 520 displays a rendered game table surface 521 to all the players. As shown in FIG. 5, the rendered game table may look similar to a physical playing table, for example playing table 300 as shown in FIG. 3.

Such a device may also implement computer controlled bots to add additional players. For illustrative purposes an clarity, embodiments intended for a single user are described herein.

At the start of the game one or more sets of instructions may cause a processor to display to the user, via a display device, a virtual card table. A virtual card table may look similar to the card tables as depicted in FIGS. 2-3, or a virtual card table may simply be displayed as a blank screen upon which virtual cards are displayed.

Following an embodiment of the rules already described for Draw 21 or a similar card game, the instructions stored in memory will cause the processor to prompt the user to place the initial blind bet (e.g., via graphical interface presented via a display device). As with the physical card game, blind bet limits can be pre-programmed to be set based on house limits or situational dependent. For example, according to an embodiment, blind bet limits will increase after each round of a game. The user can input bets by making a selection via a user interface presented on an display/interface device, for example a graphical interface associated with a touch screen display. Input bets can be credited from a network-connected virtual account (e.g. a virtual currency account not tied to actual currency) or an electronic account associated with actual currency. According to some embodiments, the user can input bets by inserting chips or tokens or actual currency into a machine associated with the standalone game device. According to some embodiments the user can input bets by sliding a card (e.g. credit card) in a machine associated with the game device and selecting a bet amount to draw from the card via graphical user interface presented on a display device. Bets for the computer controlled players can be generated according to artificial intelligence algorithms.

Once the user has input his bets and the processor has generated bets for the computer-controlled bots, instructions stored in memory will cause the processor to deal or assign an initial hand of virtual cards (e.g., a hand of two cards) to each of the plurality of players. In a single user implementation this can involve dealing or assigning an initial hand of two virtual cards to the human user and displaying the dealt virtual cards to the user via the display device and dealing or assigning initial hands of two virtual cards to one or more computer controlled bots. According to some embodiments, a processor associated with the game device deals cards by randomly generating virtual cards using a random number generator. According to some embodiments, a processor associated with the game device deals cards by randomly generating a “shuffled” or randomly ordered deck of virtual cards and selecting sets of virtual cards from the randomly ordered deck of virtual cards.

Following the rules already described for Draw 21 or a similar card game, if upon the initial deal any of the plurality of players (including the human user and the computer-controlled players) have a predetermined hand those players are declared the winner and receive the payout of the pot. For example, in a single-user implementation according to an embodiment, if the human user receives a predetermined hand (e.g. natural 21), the virtual cards are displayed to the user via the display device with a notification that the human user has won the game. If none of the computer-controlled bots received the predetermined hand, the human user will receive the entire pot. According to some embodiments, instructions stored in memory will cause the processor to credit the user virtual currency or real currency electronically (e.g., by crediting a bank account) or may cause a machine (e.g. a payout device 540 with reference to FIG. 5) associated with the standalone computer game to pay out actual currency, for example, through releasing coins and/or dollar bills in the amount of the user's winnings. If a computer controlled player has the predetermined hand, but not the human user, the computer controlled player will be declared the winner and the human user's bets will be forfeited.

If none of the plurality of players (including the human user and the computer-controlled players) are dealt the predetermined hand, instructions stored in memory will cause the processor to prompt the user (e.g., via a graphical interface via a display device) for input regarding player action. As explained earlier, according to the rules of some embodiments, play action can involve hitting for additional cards or standing with the cards already dealt. Again, a player may hit as many times as they wish until their hand reaches or exceeds a threshold value (e.g. 21). A human user can provide input indicating their action to hit or stand via a input device (e.g., a touch screen display device). According to some embodiments, player action decisions by computer-controlled players are based on artificial intelligence algorithms modeled after human players of various skill levels. According to some embodiments, player action decisions by computer-controlled players are based on situational rules. For example, depending on specific rules of a particular game, computer-controlled players will always hit until they reach a threshold value (e.g., 21).

After all player action is completed, instructions stored in memory will cause the processor to determine one or more winning hands based on comparing the virtual cards of each of the plurality of players (including the human user and the computer-controlled players). Following the rules already described for Draw 21 or a similar card game, the winning hand can be based on total value of the hand (e.g., highest value or closest to 21) or may be based on ranked poker hand categories. For example, in a single-user implementation, if the human user has the winning hand, the virtual cards will be displayed to that user via the display device with a notification that the human user has won the game. If none of the computer controlled bots received the predetermined hand, the human user will receive the entire pot. According to some embodiments, instructions stored in memory will cause the processor to credit the user virtual currency or real currency electronically (e.g., by crediting a bank account) or will cause a machine associated with the standalone computer game to pay out actual currency, for example, through releasing coins and/or dollar bills in the amount of the user's winnings. If a computer controlled player has the wining hand, but not the human user, the computer controlled player will be declared the winner and the human user's bets will forfeited. If both the human user and one or more computer controlled players tie for the winning hand, the user may instructions may cause the processor to pay the user a fraction of the total pot.

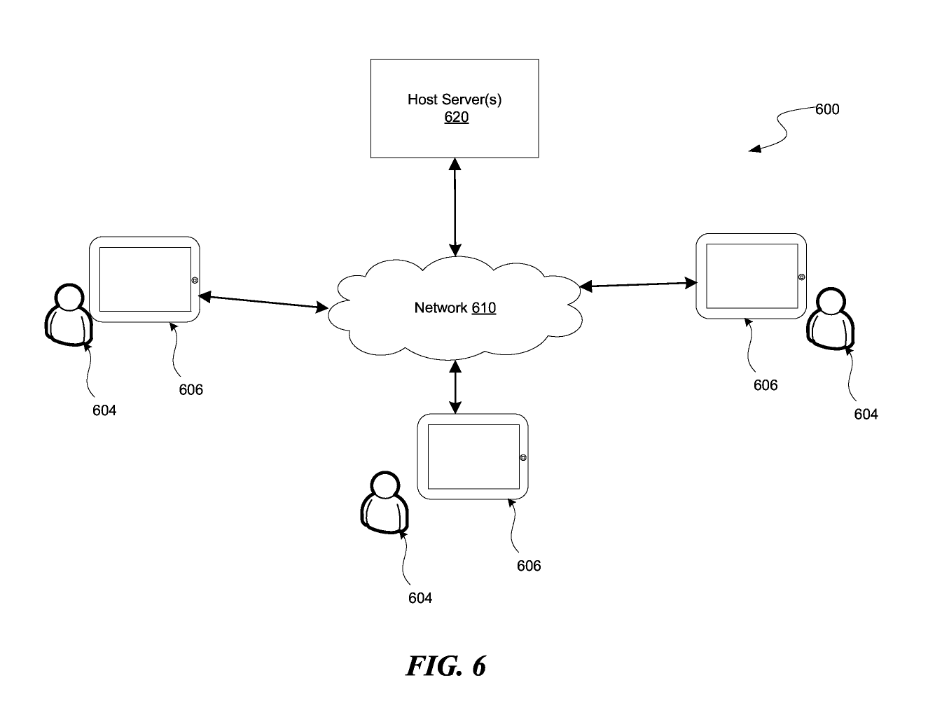

FIG. 6 shows a high-level schematic diagram of a system 600 for providing an online game of Draw 21, or similar card game, to a plurality of remote human users 604 via network connected user devices 606.

According to some embodiments, system 600 comprises a plurality of user devices 606 connected to one or more host servers 620 via a network 610. User devices 606 are illustrated in FIG. 6 as a tablet devices (e.g. an Apple iPad®), however user devices 606 may any combination of hardware and/or software capable of storing a set of instructions and executing processes based on those instructions, for example similar to computer system 400 described with reference to FIG. 4. Similarly, according to some embodiments, the one or more host servers 620 can be physical server devices including components similar to those of computer system 400 described with reference to FIG. 4. The hardware components of host server(s) 620 may be housed in a single device (e.g., server computer) at a single physical location or may comprise a distributed network of physical devices (e.g. server computers) located at a plurality of physical locations and connected via a network (e.g., network 610).

All of the aforementioned computing devices, including user devices 606, computing devices associated with host server(s) 620 may be connected to each other through one or more wired and/or wireless networks, for example network 610. In general, network 610 may be a cellular network, a telephonic network, an open network, such as the Internet, or a private network, such as an intranet and/or the extranet, or any combination or variation thereof. For example, the Internet can provide file transfer, remote log in, email, news, RSS, cloud-based services, instant messaging, visual voicemail, push mail, VoIP, and other services through any known or convenient protocol, such as, but not limited to the TCP/IP protocol, Open System Interconnections (OSI), FTP, UPnP, iSCSI, NSF, ISDN, PDH, RS-232, SDH, SONET, etc.

The network 610 may comprise any collection of distinct networks operating wholly or partially in conjunction to provide connectivity to computing devices and may appear as one or more networks to the serviced systems and devices. In one embodiment, communications to and from the devices is achieved by, an open network, such as the Internet, or a private network, such as an intranet and/or the extranet. In one embodiment, communications can be achieved by a secure communications protocol, such as secure sockets layer (SSL), or transport layer security (TLS).

For example, communications may be achieved via networks, such as, but not limited to, one or more of, a Local Area Network (LAN), a Wireless Local Area Network (WLAN), a Personal area network (PAN), a Campus area network (CAN), a Metropolitan area network (MAN), a Wide area network (WAN), a Wireless wide area network (WWAN), or any other network capable of broadband communication through technologies such as, but not limited to, Global System for Mobile Communications (GSM), Personal Communications Service (PCS), Bluetooth, WiFi, Fixed Wireless Data, 2G, 2.5G, 3G (e.g., WCDMA/UMTS based 3G networks), 4G, IMT-Advanced, pre-4G, LTE Advanced, mobile WiMax, WiMax 2, WirelessMAN-Advanced networks, enhanced data rates for GSM evolution (EDGE), General packet radio service (GPRS), enhanced GPRS, iBurst, UMTS, HSPDA, HSUPA, HSPA, HSPA+, UMTS-TDD, 1×RTT, and EV-DO.

According to some embodiments, users 604 access on online game of Draw 21, or a similar online card game, via client software instantiated on their respective user devices 606, or via a web interface through a web browser instantiated on their respective computing device 606. Client software and/or web browser applets instantiated at user devices 606 can include instructions for carrying out processes including but not limited to, receiving inputs, transmitting and receiving data from the host server (or other services—not shown) and displaying outputs (e.g. via display devices associated with the user devices 606).

According to some embodiments, the online card game is provided by the host server(s) 620 to the plurality of users 604 via user devices 606 in a similar way in which the standalone game device (previously discussed) provided the game to a single user. Here, inputs and outputs are transmitted across network 610, with the processing of instructions according to the rules of the card game being performed by the host server(s) 620, the user devices 606, or any combination thereof. It will be understood that processing of tasks associated with providing the game may be distributed among the various devices of the network according to their capabilities. For example, if graphical processing capabilities are limited at a user device 606, host server 620 render the graphical outputs in the cloud and stream video comprising the graphical outputs (or portions thereof) to the user device 606 via network 610.

What is claimed is:

1. A method of providing a card game, the method comprising:
providing a physical table and a physical deck of cards;
enabling each of a plurality of players to place a blind bet in a first designated area on the physical table;
dealing a plurality of physical cards from the physical deck of cards deck face down on the physical table in front of each of the plurality of players;
wherein, each physical card in the deck has an associated value; and
determining one or more winning players, wherein the determining includes:
if one or more of the plurality of players have a predetermined hand:
declaring each of the one or more players who have the winning hand to be a winning player; and
if none of the plurality of players has the predetermined hand, then
providing each of the plurality of players with an option to stand or be dealt one or more additional cards,
wherein, each player may be dealt an additional card only if the value of said player's current hand is less than or equal to a threshold value;
wherein, if said player's hand exceeds the threshold value, said player remains in the game;
determining one or more winning hands based on a comparison between the hands of each of the plurality of players; and
declaring each of the one or more players who have the winning hand to be a winning player.

2. The method of claim 1, wherein the predetermined hand consists of a natural 21.

3. The method of claim 1, wherein the threshold value is 21.

4. The method of claim 1, wherein determining the one or more winning hands includes identifying the one or more hands with the highest combined value.

5. The method of claim 1, wherein determining the one or more winning hands includes identifying the one or more hands with a combined value closest to the threshold value.

6. The method of claim 1, wherein determining the one or more winning hands includes identifying the one or more hands with the highest ranked poker hand.

7. The method of claim 1, further comprising:
responsive to determining the one or more winning players, combining all the bets placed on the physical table into a pot; and
distributing the pot to the one or more winning players.

8. The method of claim 1, wherein the physical table includes:
a substantially semicircular surface having a straight side and a curved side;
a surface pattern on the surface indicating a dealer position and seven player positions;
wherein, the dealer position is located along the straight side and the player positions are located along the curved side;
wherein, each player position includes a pattern indicating the first designated area on the physical table.

9. The method of claim 1, further comprising:
providing each of the plurality of players with an option to place a side bet in a second designated area on the physical table prior to dealing the physical cards; and
if one or more of the players have the predetermined hand, declaring each of the one or more players to be a winning player; and
if the one or more of the declared winning players placed the side bet in the second designated area on the physical table prior to the dealing of the physical cards;
paying a bonus to each of the winning players who placed the side bet in the second designated area, based on the amount of their respective side bets.

10. A machine-implemented method for providing a card game, the method comprising:
receiving, via an input device, a blind bet from at least one of a plurality of players;
dealing, by a processor, a plurality of virtual cards from a virtual card deck to each of the plurality of players,
displaying, via a display device, the dealt virtual cards to at least one of the plurality of players;
wherein each virtual card has an associated value;
determining, by the processor, one or more winning players of the game, wherein the determining comprises:
if one or more of the plurality of players is dealt a predetermined set of virtual cards: declaring, by the processor, the one or more players, the winning players; and
if none of the plurality of players are dealt the predetermined hand:
presenting, via the display device, an option to the at least one of the plurality of players to stand or be dealt one or more additional cards;
wherein, each player may only be dealt additional cards if the combined value of their currently assigned cards is less than or equal to a threshold value;
wherein, if said player's hand exceeds the threshold value, said player remains in the game;
receiving, via the input device, a selection by the at least one of the plurality of players to stand or be dealt additional cards;
dealing, by the processor, additional cards to the at least one player based on the received selection;
determining, by the processor, one or more winning hands based on a comparison between the hands of each of the plurality of players; and
declaring, by the processor, the one or more players with the winning hands, the winning players; and
displaying, via the display device, a result of the game, wherein the result includes the declared one or more winning players.

11. The method of claim 10, wherein dealing virtual cards includes:
randomly generating virtual cards using a random number generator.

12. The method of claim 10, wherein at least one or the plurality of players is a computer generated entity controlled by the processor.

13. The method of claim 10, wherein the predetermined hand consists of a natural 21.

14. The method of claim 10, wherein the threshold value is 21.

15. The method of claim 10, wherein determining the one or more winning hands includes identifying, by the processor, the one or more hands with the highest combined value.

16. The method of claim 10, wherein determining the one or more winning hands includes identifying, by the processor, the one or more hands with a combined value closest to the threshold value.

17. The method of claim 10, wherein determining the one or more winning hands includes identifying, by the processor, the one or more hands with the highest ranked poker hand.

18. The method of claim 10, further comprising:
responsive to declaring the one or more winning players, calculating, by the processor, a total pot based on the received bets;
displaying, via the display device, the total pot; and
if at least one of the one or more winning players is a human player, transferring, via a payout device, at least a portion of the total pot to the human player.

19. The method of claim 10, further comprising:
prior to dealing any cards, presenting, via the display device, an option to at least one of the plurality of players to place a side bet;
receiving, via the input device, an election from at least one of the plurality of players to place the side bet, wherein,
if one or more of the plurality of players is dealt the predetermined set of virtual cards:
declaring, by the processor, the one or more players the winning players; and
if the one or more of the declared winning players elected to place the side bet:
calculating, by the processor, a bonus based on the predetermined hand and the placed side bet;
displaying, via the display device, the calculated bonus to at least one of the plurality of players; and
if at least one of the one or more declared winning players is a human player, transferring, via a payout device, at least a portion of the bonus to the human player.

20. A system for providing a card game, the system comprising:
a processor;
an input device;
a display device; and
a memory having instructions stored thereon, which when executed by the processor, cause the processor to:
receive, via the input device, a blind bet from at least one of a plurality of players;
deal, by the processor, a plurality of virtual cards from a virtual card deck to each of the plurality of players;
display, via the display device, the dealt virtual cards to at least one of the plurality of players;
wherein, each virtual card has an associated value;
determine, by the processor, one or more winning players of the game, wherein the determining comprises:
if one or more of the plurality of players is dealt a predetermined set of virtual cards:
declaring, by the processor, the one or more players, the winning players; and
if none of the plurality of players are dealt the predetermined set of virtual cards:
presenting, via the display device, an option to the at least one of the plurality of players to stand or be dealt one or more additional cards;
wherein, each player may only be dealt additional cards if the combined value of their currently assigned cards is less than or equal to a threshold value;
wherein, if said player's hand exceeds the threshold value, said player remains in the game;
receiving, via the input device, a selection by the at least one of the plurality of players to stand or be dealt additional cards;
dealing, by the processor, additional cards to the at least one player based on the received selection;
determining, by the processor, one or more players with the winning hands, the winning players; and
declaring, by the processor, the one or more players with the winning hands, the winning players; and
display, via the display device, a result of the game, wherein the result includes the declared one or more winning players.

21. The system of claim 20, wherein at least one or the plurality of players is a computer generated entity controlled by the processor based on instructions stored in the memory.

22. The system of claim 20, wherein the predetermined hand consists of a natural 21.

23. The system of claim 20, wherein the threshold value is 21.

24. The system of claim 20, wherein determining the one or more winning hands includes identifying, by the processor, the one or more hands with the highest combined value.

25. The system of claim 20, wherein determining the one or more winning hands includes identifying, by the processor, the one or more hands with a combined value closest to the threshold value.

26. The system of claim 20, wherein determining the one or more winning hands includes identifying, by the processor, the one or more hands with the highest ranked poker hand.

27. The system of claim 20, further comprising:
a payout device;
wherein, the memory has instructions stored thereon, which when executed by the processor, cause the processor to further:
responsive to declaring the one or more winning players, calculate a total pot based on the received bets;
display, via the display device, the total pot; and
if at least one of the one or more winning players is a human player, transfer, via a payout device, at least a portion of the total pot to the human player.

28. The system of claim 20, further comprising:
a payout device;
wherein, the memory has instructions stored thereon, which when executed by the processor, cause the processor to further:
prior to dealing any cards, present, via the display device, an option to at least one of the plurality of players to place a side bet;
receive, via the input device, an election from at least one of the plurality of players to place the side bet, wherein,
if one or more of the plurality of players is dealt the predetermined set of virtual cards:
declare, by the processor, the one or more players the winning players; and
if the one or more of the declared winning players elected to place the side bet:
calculate, by the processor, a bonus based on the predetermined hand and the placed side bet;
display, via the display device, the calculated bonus to at least one of the plurality of players; and
if at least one of the one or more declared winning players is a human player, transfer, via a payout device, at least a portion of the bonus to the human player.
